(19) United States
(12) Patent Application Publication
(10) Pub. No.: US 2026/0107091 A1
(43) Pub. Date: Apr. 16, 2026

(54) VEHICLE AUDIO SYSTEM BASED ON DRIVING CHANNEL MULTIPLEXING, AUDIO PLAYING METHOD, AND DEVICE

(71) Applicant: AAC Acoustic Technologies (Shanghai) Co., Ltd., Shanghai (CN)

(72) Inventors: Huan Ge, Shanghai (CN); Hongxing Wang, Shanghai (CN)

(21) Appl. No.: 18/969,208

(22) Filed: Dec. 4, 2024

Related U.S. Application Data
(63) Continuation of application No. PCT/CN2024/124471, filed on Oct. 12, 2024.

(51) Int. Cl. H04R 5/04

(52) U.S. Cl. CPC H04R 5/04; H04R 2420/01; H04R 2499/13

(57) ABSTRACT

The present invention provides a vehicle audio system based on drive channel multiplexing, which includes an audio obtaining module, a signal processing module and a power amplification module. The audio obtaining module configured to obtain audio source data and an audio mode instruction. The signal processing module configured to process a corresponding audio mode for the audio source data according to the audio mode instruction. The power amplification module configured to: receive a signal output by the signal processing module and amplify the signal to obtain an audio signal. The power amplification module is connected to a channel switching module through a group of drive channels. The present invention can reduce the number of the audio drive channels.

### CROSS-REFERENCE TO RELATED APPLICATIONS

This application is a continuation of International Application No. PCT/CN2024/124471, filed on Oct. 12, 2024, the entire content of which is incorporated herein by reference.

### TECHNICAL FIELD

Embodiments of the present invention relates to the field of vehicle audios, and in particular, to a vehicle audio system based on drive channel multiplexing, an audio playing method, and a device.

### BACKGROUND

With the development of vehicle audio systems, the number of loudspeakers used in a vehicle audio system increases. Meanwhile, with the diversification of in-vehicle audio functions, internal loudspeakers have also been arranged at positions such as a headrest, an A/B pillar, and a ceiling, to meet various audio function requirements, such as active noise reduction and an independent range. When there are many loudspeakers introduced into a vehicle, or many loudspeakers need to be introduced to a plurality of positions in the vehicle, to support operations of the loudspeakers, one drive channel is introduced for each loudspeaker. As a result, more drive channels are additionally added for the audio system of entire vehicle.

Namely, vehicles with rich in-vehicle audio functions have a high demand for the number of channels of audio amplifiers. To fully meet various audio function requirements, 40 to 50 or more channels may be provided in an in-vehicle power amplifier. It is hard to achieve mass production within a short period.

### SUMMARY

Embodiments of the present invention aim to provide a vehicle audio system based on drive channel multiplexing, an audio playing method, and a device, which can reduce a number of audio drive channels without reducing in-vehicle audio functions.

In order to solve the technical problem, the present invention provides a vehicle audio system based on drive channel multiplexing, which includes an audio obtaining module, a signal processing module and a power amplification module. The audio obtaining module configured to obtain audio source data and an audio mode instruction. The signal processing module configured to process a corresponding audio mode for the audio source data according to the audio mode instruction. The power amplification module configured to: receive a signal output by the signal processing module and amplify the signal to obtain an audio signal. The power amplification module is connected to a channel switching module through a group of drive channels. The channel switching module is connected to a first audio device group and a second audio device group respectively through a first drive sub-channel group and a second drive sub-channel group to switch a first drive sub-channel and/or a second drive sub-channel corresponding to the audio mode to be opened according to the audio mode instruction, to cause the audio signal to drive a target audio device.

In one embodiment, the power amplification module is connected to a portion of first audio devices in the first audio device group and a portion of second audio devices in the second audio device group respectively through two groups of direct drive channels. Each direct drive channel is connected to a first audio device or a second audio device.

In one embodiment, the channel switching module is connected to all the first audio devices, except the portion of first audio devices, in the first audio device group through the first drive sub-channel group, and to all the second audio devices, except the portion of second audio devices, in the second audio device group through the second drive sub-channel group.

Each first drive sub-channel in the first drive sub-channel group is connected to one first audio device, and each second drive sub-channel in the second drive sub-channel group is connected to one second audio device.

In one embodiment, the channel switching module is connected to all first audio devices in the first audio device group through the first drive sub-channel group, and to all second audio devices in the second audio device group through the second drive sub-channel group. Each first drive sub-channel is connected to one of the first audio devices, and each second drive sub-channel is connected to one of the second audio devices.

In one embodiment, the channel switching module is configured to route and branch the group of drive channels into the first drive sub-channel group and the second drive sub-channel group. Each drive channel in the group of drive channels is routed to one of the first drive sub-channels and one of the second drive sub-channels; and a number of the first drive sub-channels in the first drive sub-channel group is the same as a number of the second drive sub-channels in the second drive sub-channel group.

In one embodiment, the channel switching module is configured to branch the group of drive channels to the first drive sub-channel group and the second drive sub-channel group.

Each drive channel in the group of drive channels is respectively routed to one of the first drive sub-channels and at least one of the second drive sub-channels; and a number of the first drive sub-channels in the first drive sub-channel group is different from a number of the second drive sub-channels in the second drive sub-channel group.

In one embodiment, the second audio device group is any one of a headrest loudspeaker group, an A/B-pillar loudspeaker group, a ceiling loudspeaker group, a loudspeaker array, and a seat vibrator group; and the first audio device group includes audio devices except the second audio device group among the audio devices of entire vehicle.

The present invention further provides an audio playing method, applied to the vehicle audio system based on drive channel multiplexing described above. The audio playing method includes obtaining audio source data and an audio mode instruction, and processing a corresponding audio mode for the audio source data according to the audio mode instruction. Amplifying the processed audio source data to obtain an audio signal. Switching a first drive sub-channel and/or a second drive sub-channel corresponding to the audio mode to be opened according to the audio mode instruction, to cause the audio signal to drive a target audio device.

The present invention further provides an electronic device, which includes at least one processor and a memory communicably connected with the at least one processor.

The memory has instructions executable by the at least one processor. The instructions, when executed by the at least one processor, cause the hat least one processor to perform the method described above.

The present invention further provides a computer-readable storage medium, having a computer program stored thereon. The program is run by a processor to implement the method described above.

In the embodiments of the present invention, by the arrangement of the channel switching module and in combination with the audio mode instruction, when the audio mode instruction indicates different modes, the channel switching module controls connection switching between the first drive sub-channels and/or the second drive sub-channels (audio power amplification channels) and different target audio devices, thereby achieving different working states of different audio devices at different moments. Thus, a total number of the power amplification channels required by the audio system of entire vehicle is reduced, and the mass production possibility of a plurality of complex audio system schemes in the vehicle is increased.

### BRIEF DESCRIPTION OF THE DRAWINGS

One or more embodiments are illustrated by images in corresponding drawings, and these exemplary explanations are not to be construed as limiting the embodiments.

FIG. 1 is a schematic structural diagram I of a vehicle audio system based on drive channel multiplexing according to an embodiment of the present invention;

FIG. 2 is a schematic structural diagram II of a vehicle audio system based on drive channel multiplexing according to an embodiment of the present invention;

FIG. 3 is a schematic structural diagram III of a vehicle audio system based on drive channel multiplexing according to an embodiment of the present invention;

FIG. 4 is a schematic structural diagram IV of a vehicle audio system based on drive channel multiplexing according to an embodiment of the present invention;

FIG. 5 is a schematic structural diagram V of a vehicle audio system based on drive channel multiplexing according to an embodiment of the present invention;

FIG. 6 is a schematic structural diagram VI of a vehicle audio system based on drive channel multiplexing according to an embodiment of the present invention;

FIG. 7 is a schematic structural diagram VII of a vehicle audio system based on drive channel multiplexing according to an embodiment of the present invention;

FIG. 8 is a schematic structural diagram VIII of a vehicle audio system based on drive channel multiplexing according to an embodiment of the present invention;

FIG. 9 is a schematic structural diagram IX of a vehicle audio system based on drive channel multiplexing according to an embodiment of the present invention; and

FIG. 10 is a schematic structural diagram of an electronic device according to an embodiment of the present application.

### DETAILED DESCRIPTION OF THE EMBODIMENTS

To make the objectives, technical solutions, and advantages of the embodiments of the present invention clearer, the following will describe the various embodiments of the present invention in detail with reference to the accompanying drawings. However, those of ordinary skill in the art can understand that in the various embodiments of the present invention, numerous technical details are set forth in order to enable readers to better understand the present invention. However, the technical solutions claimed by the present invention can also be implemented even without these technical details and the various changes and modifications based on the following embodiments. The classification of the following embodiments is for convenience of description and should not constitute any limitation on the specific implementations of the present invention. The various embodiments can be combined and referenced to each other without contradictions. It should be noted that the following content is only for ease of understanding implementation details provided, and is not necessary for implementing this scheme.

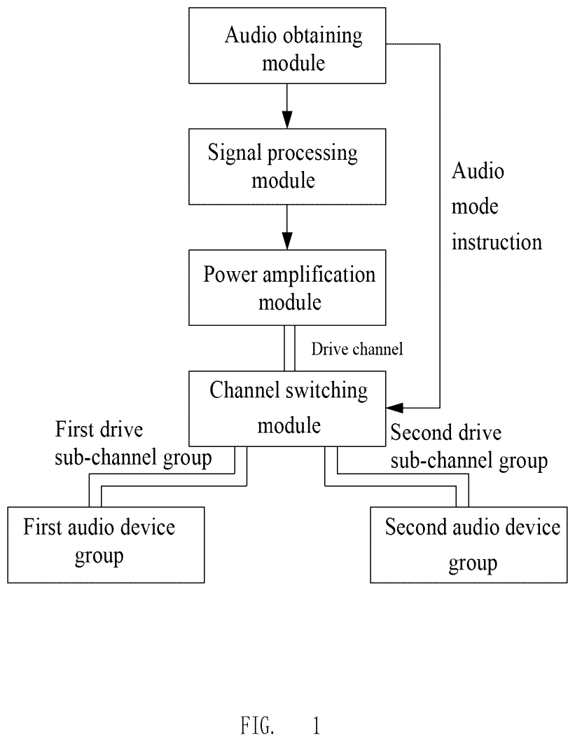

An embodiment of the present invention relates to a vehicle audio system based on drive channel multiplexing. As shown in FIG. 1, the vehicle audio system based on drive channel multiplexing in this embodiment specifically includes the following content.

an audio obtaining module, configured to obtain audio source data and an audio mode instruction; a signal processing module, configured to process a corresponding audio mode for the audio source data according to the audio mode instruction; and a power amplification module, configured to: receive a signal output by the signal processing module and amplify the signal to obtain an audio signal. The power amplification module is connected to a channel switching module through a group of drive channels. The channel switching module is connected to a first audio device group and a second audio device group respectively through a first drive sub-channel group and a second drive sub-channel group to switch a first drive sub-channel and/or a second drive sub-channel corresponding to the audio mode according to the audio mode instruction, to cause the audio signal to drive a target audio device.

Specifically, as shown in FIG. 1, an in-vehicle infotainment issues, according to a user instruction or an actual application scenario (such as a music playing or incoming call scenario), an instruction for switching an audio mode. The audio mode can include a music mode, a navigation mode, a call mode, a privacy mode, and the like. The present application does not impose a specific restriction on this. Different audio modes correspond to different loudspeakers or vibrators working in audio devices of entire vehicle. The vehicle audio system of this embodiment obtains, through the audio obtaining module, an audio mode instruction of a user and audio source data that is correspondingly played under the audio mode instruction. After the audio source data and the audio mode instruction are obtained, the audio obtaining module may transmit the audio source data and the audio mode instruction to the signal processing module, and transmits the audio mode instruction to the channel switching module. The signal processing module can perform digital to analog conversion on the audio source data, and converts it into an analog signal. The analog signal is then amplified by the power amplification module to obtain an audio signal that can drive an audio device to produce sound, and the audio signal is transmitted to the channel switching module. In this process, since the audio source data may be different, the audio mode indicated by the audio mode instruction may be different too. Therefore, the signal processing module may further process a corresponding mode for the audio mode indicated by the audio mode instruction. The processing step needing to be performed on each audio mode may be set in advance. The present invention does not impose a specific limitation on the specific processing step performed on each audio mode in the signal processing module.

Moreover, since the channel switching module has received in advance the audio mode instruction transmitted by the audio obtaining module, it can determine, according to the audio mode instruction, the audio mode indicated by the user. The audio modes correspond to different audio devices to be driven, and the audio device correspondingly driven by each audio mode can be set in advance. Namely, each audio mode corresponds to a drive channel to be opened by the channel switching module. The channel switching module is connected to a first audio device group and a second audio device group respectively through a first drive sub-channel group and a second drive sub-channel group. Correspondingly, after the channel switching module receives, through a group of drive channels, the audio signal transmitted by the power amplification module, the channel switching module switches a first drive sub-channel and/or a second drive sub-channel corresponding to the audio mode to be opened according to the audio mode instruction, to cause the audio signal to drive a target audio device. The target audio device may be either a first audio device in the first audio device group or a second audio device in the second audio device group, or may include both a first audio device in the first audio device group and a second audio device in the second audio device group. The present application does not impose a specific limitation on this.

Compared with the related technology, in the above embodiment of the present invention, by the arrangement of the channel switching module and in combination with the audio mode instruction, when the audio mode instruction indicates different modes, the channel switching module controls connection switching between the first drive sub-channels and/or the second drive sub-channels (audio power amplification channels) and different target audio devices, thereby achieving different working states of different audio devices at different moments. Thus, a total number of the power amplification channels required by the audio system of entire vehicle is reduced, and the mass production possibility of a plurality of complex audio system schemes in the vehicle is increased.

Another embodiment of the present invention relates to a vehicle audio system based on drive channel multiplexing. The content of this embodiment is a detail of the foregoing embodiment, specifically including the following content.

In an example, the power amplification module is connected to a portion of first audio devices in the first audio device group and a portion of second audio devices in the second audio device group respectively through two groups of direct drive channels. Each direct drive channel is connected to a first audio device or a second audio device.

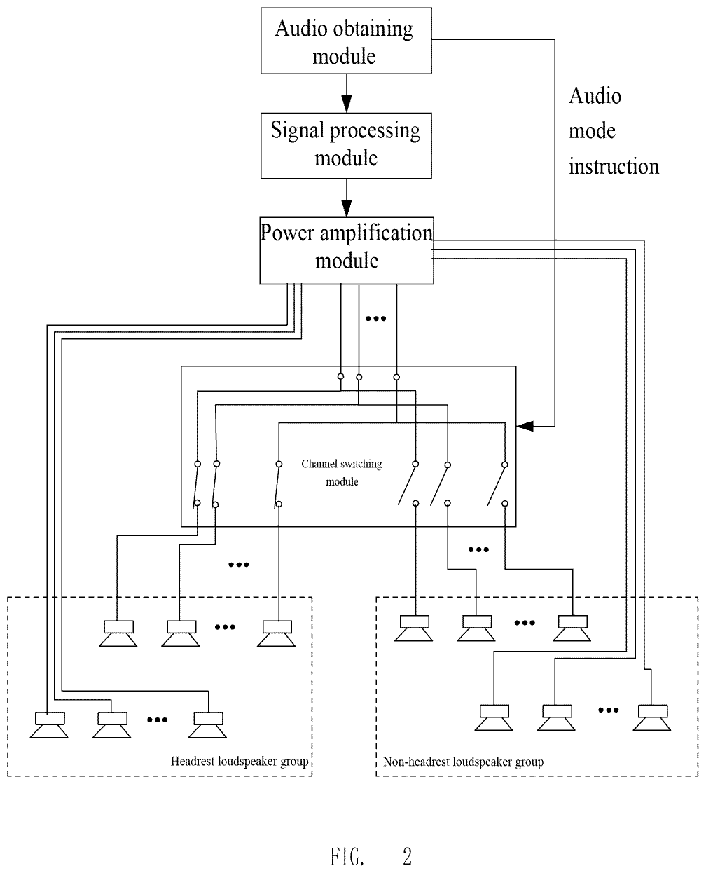

Specifically, as shown in FIG. 2, the power amplification module may have three groups of drive channels. Two groups of direct drive channels are respectively configured to be connected to a portion of the first audio devices in the first audio device group and a portion of the second audio devices in the second audio device group, and the remaining group of drive channels is connected to the channel switching module to achieve multiplexing of the group of drive channels through the channel switching module.

Correspondingly, in this case, a specific connection relationship between the channel switching channel and the first audio device group, as well as the second audio device group, respectively through the first drive sub-channel group and the second drive sub-channel group is as follows: The channel switching module is connected to all first audio devices in the first audio device group through the first drive sub-channel group, and to all second audio devices in the second audio device group through the second drive sub-channel group. Each first drive sub-channel in the first drive sub-channel group is connected to one of the first audio devices, and each second drive sub-channel in the second drive sub-channel group is connected to one of the second audio devices.

Specifically, in this embodiment, the first audio devices in the first audio device group are correspondingly connected through one group of direct drive channels connected to the power amplification module and the first drive sub-channels of the first drive sub-channel group connected to the channel switching module. The second audio devices in the second audio device group are correspondingly connected through another group of direct drive channels connected to the power amplification module and the second drive sub-channels of the second drive sub-channel group connected to the channel switching module. The second audio device group may be any one of a headrest loudspeaker group, an A/B-pillar loudspeaker group, a ceiling loudspeaker, a loudspeaker array, and a seat vibrator group; and the first audio device group includes audio devices except the second audio device group among the audio devices of entire vehicle.

It should be noted that the channel switching module can be implemented through a changeover switch controlled by a motor or a relay, or through a semiconductor power changeover switch. This embodiment does not impose a specific limitation on this. Namely, the first drive sub-channels connected to all first audio devices, except the portion of first audio devices, in the first audio device group and the second drive sub-channels connected to all second drive sub-channels, except the portion of second audio devices, in the second audio device group have two states: an on state and an off state. The channel switching module can control any first drive sub-channel and any second drive sub-channel to be switched on through the changeover switch.

For example, as shown in FIG. 2, the headrest loudspeaker group used as the second audio device group is taken as an example. In this case, an example where the first audio device group includes non-headrest loudspeakers of entire vehicle and a portion of headrest loudspeakers in the headrest loudspeaker group (the second audio device group) and a portion of non-headrest loudspeakers of entire vehicle multiplex a portion of drive channels through the channel switching module is as shown in FIG. 2. In this example, a portion of headrest loudspeakers are connected to the channel switching module, and the remaining headrest loudspeakers are directly connected to the power amplification module. In this case, assuming that the audio mode instruction indicates a whole-vehicle entertainment mode that requires both the headrest loudspeakers and other non-headrest loudspeakers to work, the headrest loudspeakers directly connected to the power amplification module can work simultaneously with the non-headrest loudspeakers of entire vehicle, thereby enhancing the audio immersion at corresponding seat positions. In a privacy mode where all the headrest loudspeakers need to work, as shown in FIG. 2, the channel switching module can switch on the headrest loudspeakers connected to the channel switching module to work simultaneously with the headrest loudspeakers directly connected to the power amplification module, thereby improving the privacy of partitioned playing of audio content.

Alternatively, in another example, the channel switching module is connected to all first audio devices in the first audio device group through the first drive sub-channel group, and to all second audio devices in the second audio device group through the second drive sub-channel group, wherein each first drive sub-channel is connected to one of the first audio devices, and each second drive sub-channel is connected to one of the second audio devices.

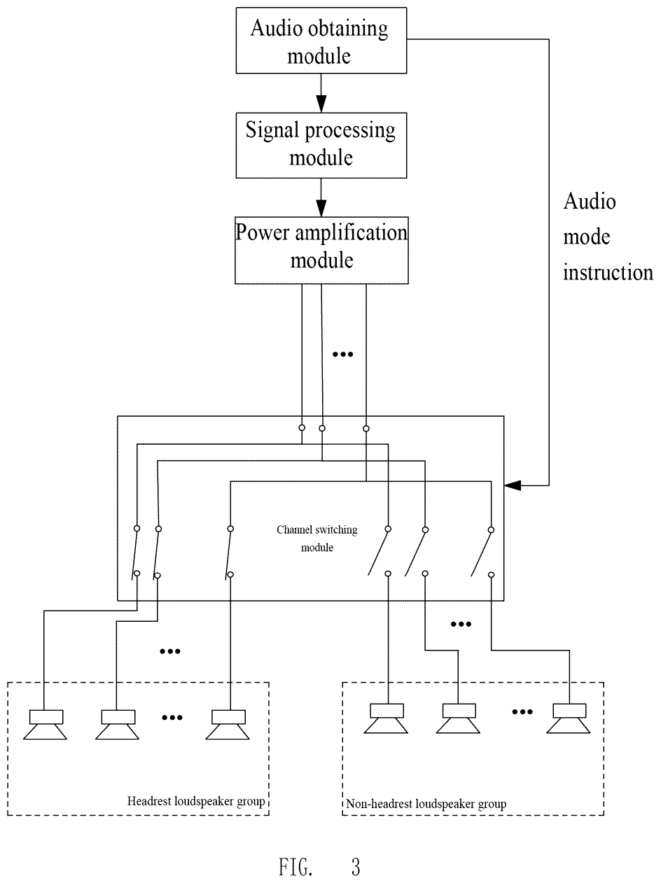

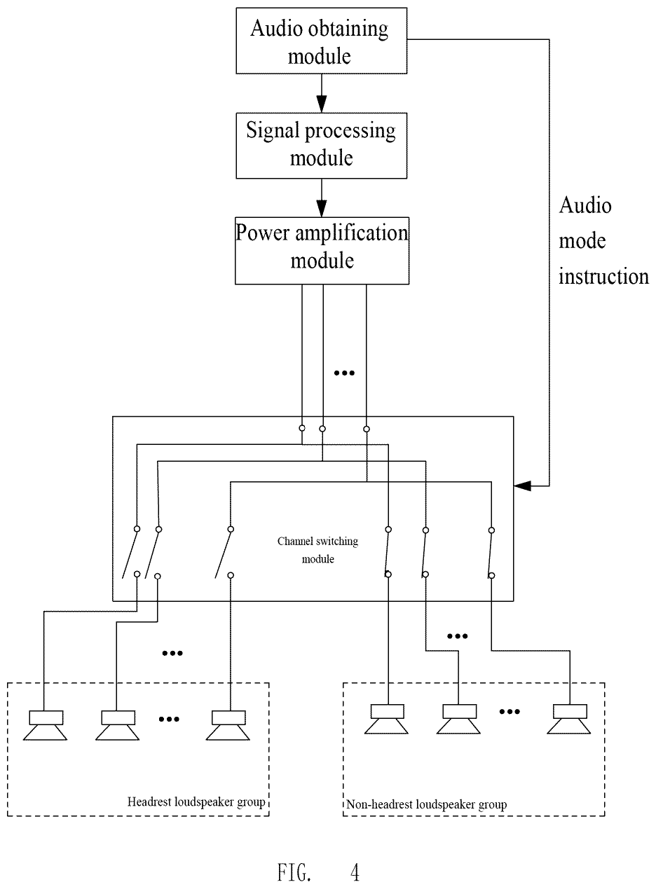

Specifically, this embodiment is an alternative embodiment to the foregoing embodiment, in which, the direct drive channel groups are not configured to be connected to the first audio device group and the second audio device group, but instead, are all connected through the first drive sub-channel group and the second drive sub-channel group by using the channel switching module. For example, the headrest loudspeaker group used as the second audio device group is taken as an example. In this case, an example where the first audio device group includes non-headrest loudspeakers of entire vehicle and a portion of headrest loudspeakers in the headrest loudspeaker group (the second audio device group) and a portion of non-headrest loudspeakers of entire vehicle multiplex a portion of drive channels through the channel switching module is as shown in FIG. 3 and FIG. 4. Under this condition, the non-headrest loudspeakers of entire vehicle connected to the channel switching module and the headrest loudspeakers do not work simultaneously. For example, in the whole-vehicle entertainment mode, as shown in FIG. 3, the channel switching module switches to be connected to the non-headrest loudspeakers of entire vehicle. In this case, the non-headrest loudspeakers of entire vehicle work, and the headrest loudspeakers do not work. In the privacy mode, as shown in FIG. 4, the channel switching module switches to be connected to the headrest loudspeakers. In this case, the headrest loudspeakers work, and the non-headrest loudspeakers of entire vehicle do not work. It should be noted that when the channel switching module switches the drive sub-channels, only a portion of channels can be selected and switched according to an actual application need, thus achieving an application scenario where a portion of headrest loudspeakers and a portion of non-headrest loudspeakers of entire vehicle work simultaneously. A number of headrest loudspeakers working simultaneously with the non-headrest loudspeakers of entire vehicle can also be flexibly adjusted according to an application need. The present application does not impose a specific restriction on this.

In addition, in this embodiment, the channel switching module is further configured to route and branch the group of drive channels into the first drive sub-channel group and the second drive sub-channel group. Each drive channel in the group of drive channels is routed to one of the first drive sub-channels and one of the second drive sub-channels; and a number of the first drive sub-channels in the first drive sub-channel group is the same as a number of the second drive sub-channels in the second drive sub-channel group.

Specifically, as shown in FIG. 2 and FIG. 3, in the group of drive channels connected to the power amplification module and the channel switching module, each drive channel is routed to one first drive sub-channel and one second drive sub-channel through the channel switching module. It should be noted that the first drive sub-channel and the second drive sub-channel which correspond to the same drive channel cannot be used simultaneously. Namely, when the first drive sub-channel corresponding to the same drive channel is switched on for transmitting an audio signal, the second drive sub-channel corresponding to the drive channel cannot transmit the audio signal.

Correspondingly, the channel switching module is configured to route and branch the group of drive channels into the first drive sub-channel group and the second drive sub-channel group. Each drive channel in the group of drive channels is routed to one of the first drive sub-channels and one of the second drive sub-channels; and a number of the first drive sub-channels in the first drive sub-channel group is different from a number of the second drive sub-channels in the second drive sub-channel group.

Specifically, in the group of drive channels connected to the power amplification module and the channel switching module, each drive channel is routed to one first drive sub-channel and at least one second drive sub-channel through the channel switching module. The present invention does not impose a limitation on a specific number of a plurality of second drive sub-channels, which may be one, two, three, or four. Since each drive channel is routed to one first drive sub-channel and the plurality of second drive sub-channel through the channel switching module, if the number of the first audio devices in the first audio device group is less than or equal to the number of the second audio devices in the second audio device group, in this embodiment, several second audio devices may be correspondingly connected to the plurality of second drive sub-channels. It should be noted that a difference between this embodiment and the foregoing embodiment is that in the foregoing embodiment, the number of the first drive sub-channels is always the same as the number of the second drive sub-channels, but in this embodiment, the number of the first drive sub-channels is different from the number of the second drive sub-channels.

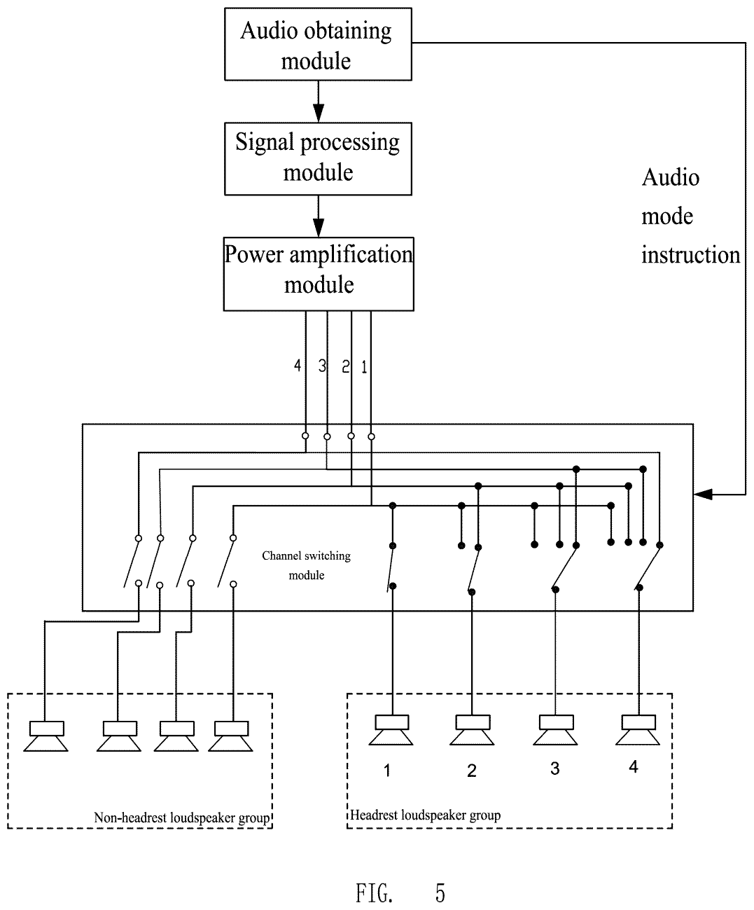

As shown in FIG. 5, four drive channels (the group of drive channels) and four headrest loudspeakers (the second audio device group) are taken as an example. The four drive channels of a power amplification module are connected to the channel switching module, and a link of each drive channel in the channel switching module is routed to a plurality of branch links respectively. In an example shown in FIG. 5, drive channel 1 is routed to a first drive sub-channel (connected to a non-headrest loudspeaker of entire vehicle) and four second drive sub-channels (connected to headrest loudspeakers 1, 2, 3, 4); drive channel 2 is routed to a first drive sub-channel (connected to a non-headrest loudspeaker of entire vehicle) and three second drive sub-channels (connected to headrest loudspeakers 2, 3, 4); drive channel 3 is routed to a first drive sub-channel (connected to a non-headrest loudspeaker of entire vehicle) and two second drive sub-channels (connected to headrest loudspeakers 3 and 4); and drive channel 4 is routed to a first drive sub-channel (connected to a non-headrest loudspeaker of entire vehicle) and two second drive sub-channels (connected to headrest loudspeaker 4). This embodiment of the present invention can achieve connection of different branch links of the same drive channel to different headrest loudspeakers, thereby achieving a function of simultaneously multiplexing one drive channel for different loudspeakers. Furthermore, this connection can be switched according to an actual application need.

Several application examples in an actual application are given below in this embodiment of FIG. 5 by taking a headrest loudspeaker group used as the second audio device group as an example. It should be noted that in the following examples, the headrest loudspeakers can be replaced with any one of A/B column loudspeakers, ceiling loudspeakers, loudspeaker arrays, or seat vibrators.

In an application situation, as shown in FIG. 5, FIG. 5 shows that the channel switching module switches all the four drive channels to the headrest loudspeakers. The four drive channels are connected to four headrest loudspeakers, and each loudspeaker is driven by an independent channel. This method can achieve a sound quality mode and privacy mode of the headrest loudspeakers. In the sound quality mode, headrest loudspeakers 1 and 3 are simultaneously configured to play a left channel of an input audio, and headrest loudspeakers 2 and 4 are simultaneously configured to play a right channel of the input audio, achieving optimal sound quality. In the privacy mode, headrest loudspeaker 1 is configured to play left channel of the input audio; headrest loudspeaker 3 is configured to counteract leakage of headrest loudspeaker 1 in a far field, to enhance the privacy; headrest loudspeaker 2 is configured to play the right channel of the input audio; and headrest loudspeaker 4 is configured to counteract leakage of headrest loudspeaker 2 in the far field, to enhance the privacy. Similarly, loudspeakers 3 and 4 can also be configured to play the input audio, and loudspeakers 1 and 2 can be configured to counteract the leakage in the far field. The present invention does not specifically limit this.

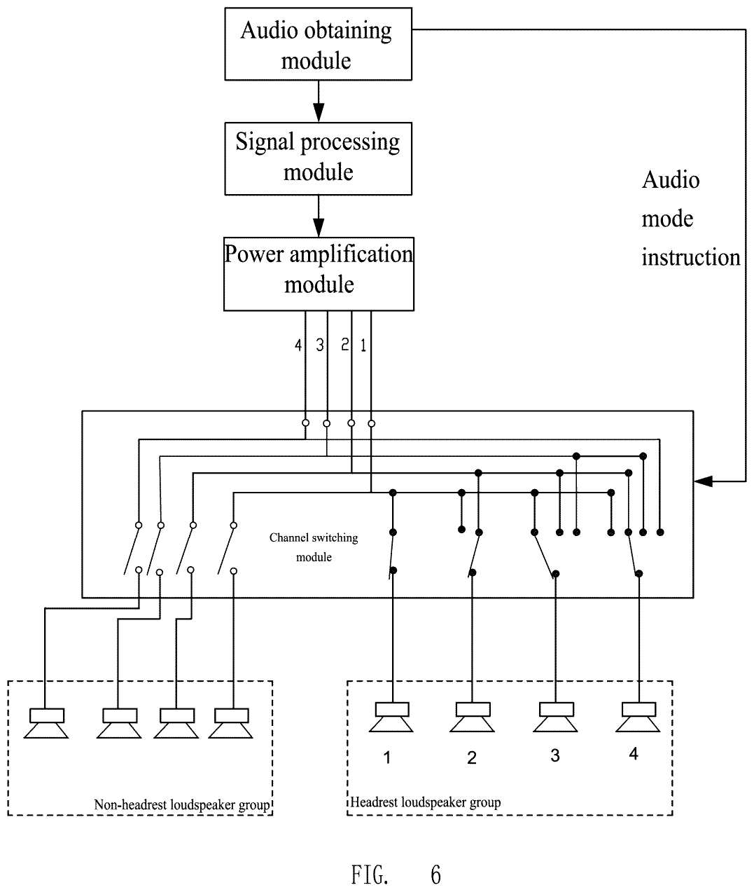

In another application scenario, as shown in FIG. 6, FIG. 6 shows an example where the channel switching module switches two drive channels to the headrest loudspeakers. Drive channel 1 simultaneously drives headrest loudspeakers 1 and 3, and drive channel 2 simultaneously drives headrest loudspeakers 2 and 4. This method can also achieve switching between a sound quality mode and a privacy mode. For example, in the sound quality mode, headrest loudspeakers 1 and 3 are configured to play a left channel of an input audio, and headrest loudspeakers 2 and 4 are configured to play a right channel of the input audio. In the privacy mode, the left and right channels of the input audio are mixed in advance to a single channel and played by headrest loudspeakers 1 and 3. Headrest loudspeakers 2 and 4 are configured to counteract leakages of headrest loudspeakers 1 and 3 in the far field. Similarly, headrest loudspeakers 2 and 4 can also be configured to play the input audio, and headrest loudspeakers 1 and 3 can be configured to counteract the leakage in the far field. It should be noted that in this case, it is not necessary for connection between each drive channel and two loudspeakers. Each drive channel can be selectively connected to one or two headrest loudspeakers (for example, drive channel 1 is only connected to loudspeaker 1, and drive channel 2 is only connected to loudspeaker 2).

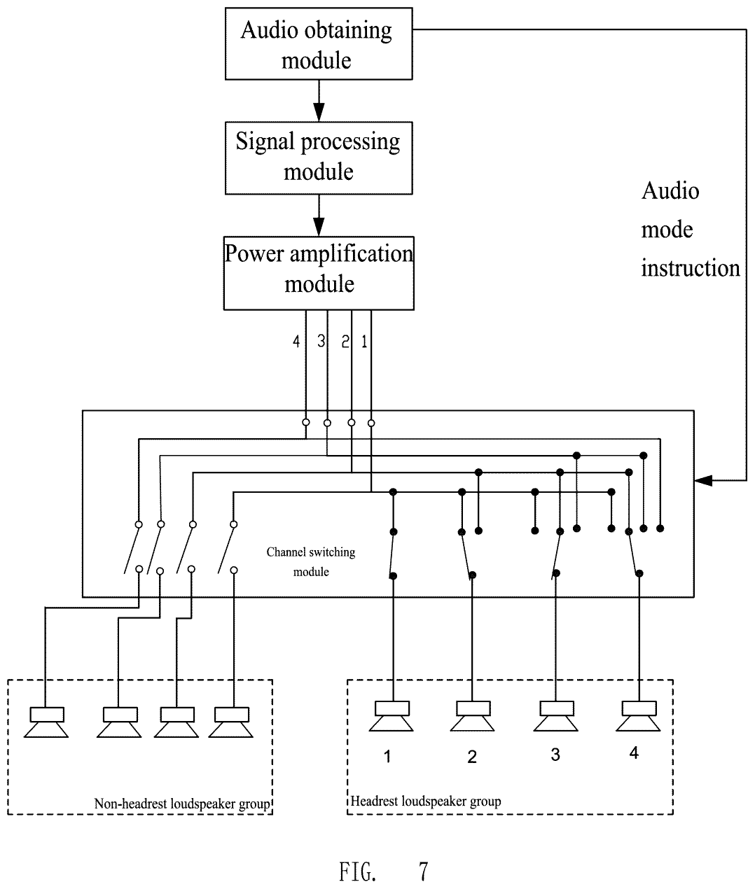

In another application scenario, as shown in FIG. 7, FIG. 7 shows an example where the channel switching module switches two drive channels to the headrest loudspeakers. Drive channel 1 simultaneously drives loudspeakers 1 and 2, and drive channel 2 simultaneously drives loudspeakers 3 and 4. In this connection method, the headrest loudspeakers can be configured to achieve a privacy mode. In this mode, left and right channels of an input audio are mixed in advance to a single channel and played by headrest loudspeakers 1 and 2. Headrest loudspeakers 3 and 4 are configured to counteract leakages of headrest loudspeakers 1 and 2 in the far field. Similarly, headrest loudspeakers 3 and 4 can also be configured to play the input audio, and headrest loudspeakers 1 and 2 can be configured to counteract the leakage in the far field.

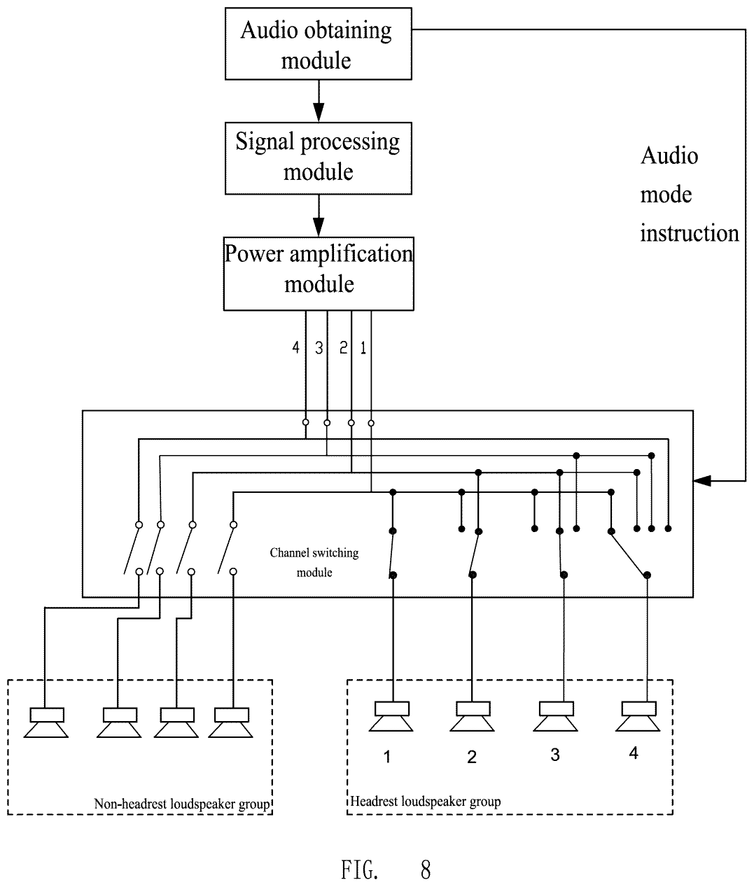

In still another application scenario, as shown in FIG. 8, FIG. 8 shows an example the channel switching module switches two drive channels to the headrest loudspeakers. Drive channel 1 simultaneously drives headrest loudspeakers 1 and 4, and drive channel 2 simultaneously drives headrest loudspeakers 2 and 3. In this connection method, the headrest loudspeakers can be configured to achieve a privacy mode. In this mode, left and right channels of an input audio are mixed in advance to a single channel and played by headrest loudspeakers 1 and 4. Headrest loudspeakers 2 and 3 are configured to counteract leakages of headrest loudspeakers 1 and 4 in the far field. Similarly, headrest loudspeakers 2 and 3 can also be configured to play the input audio, and headrest loudspeakers 1 and 4 can be configured to counteract the leakage in the far field. It should be noted that in this case, it is not necessary for connection between each drive channel and two headrest loudspeakers. Each drive channel can be selectively connected to one or two headrest loudspeakers (for example, drive channel 1 is only connected to headrest loudspeaker 1, and drive channel 2 is only connected to headrest loudspeaker 2).

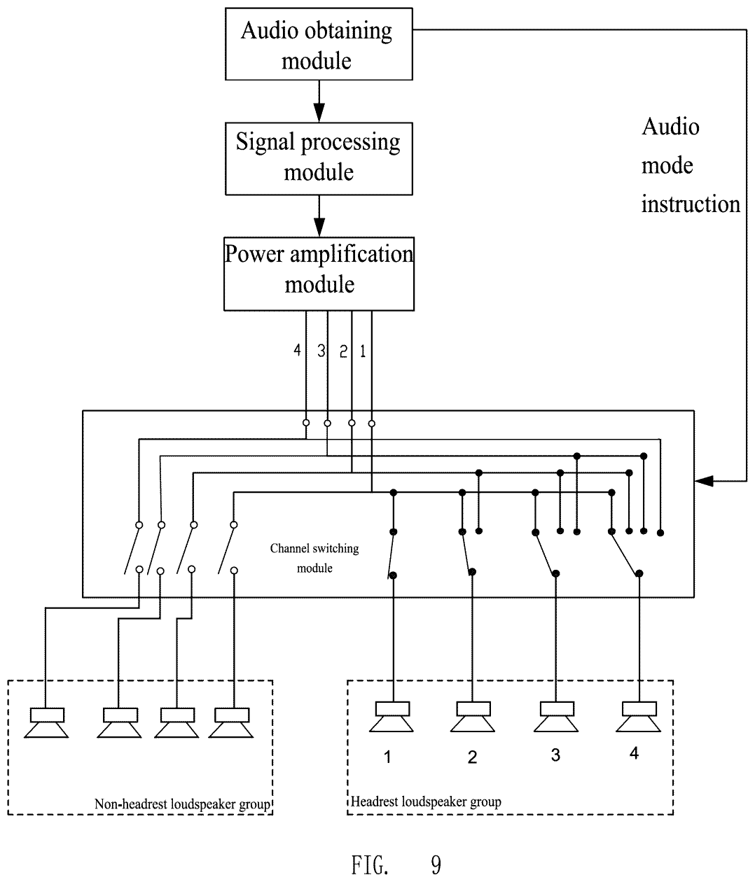

In still another application scenario, as shown in FIG. 9, FIG. 9 shows an example where the channel switching module only switches one power amplification output channel to the headrest loudspeakers. Power amplification output channel 1 simultaneously drives loudspeakers 1, 2, 3, and 4. In this connection method, the headrest loudspeakers can be configured to play a single-channel audio. In this mode, left and right channels of an input audio are mixed in advance to a single channel and played by the loudspeakers 1, 2, 3, and 4. It should be noted that in this case, it is not necessary for simultaneous connection of the power amplification output channel to the four loudspeakers. The power amplification output channel can be selectively connected to at least one of the four loudspeakers.

Compared with the related technology, this embodiment of the present invention achieves multiplexing of the drive channel by routing one drive channel into at least two drive sub-channels and connecting the sub-channels to different audio devices. Namely, since each power amplifier drive channel may correspond to one or more branch links, different branch links of the same drive channel can be connected to different audios, thereby enabling different loudspeakers to simultaneously multiplex one power amplification output channel. Furthermore, this connection can be switched according to an actual application need, to reduce the number of drive channels for the power amplification module.

Another embodiment of the present invention relates to an audio playing method, applied to the vehicle audio system based on drive channel multiplexing according to any of the above embodiments. The audio playing method specifically includes the following steps:

Step 101: Audio source data and an audio mode instruction are obtained, and a corresponding audio mode is processed for the audio source data according to the audio mode instruction.

Step 102: The processed audio source data is amplified to obtain an audio signal.

Step 103: A first drive sub-channel and/or a second drive sub-channel corresponding to the audio mode is switched to be opened according to the audio mode instruction, to cause the audio signal to drive a target audio device.

It is not difficult to find that this embodiment is a method embodiment corresponding to the embodiments of the above vehicle audio system based on drive channel multiplexing. The implementation details of this embodiment have been recorded in the above embodiments of the above vehicle audio system based on drive channel multiplexing. The present invention will not elaborate this here.

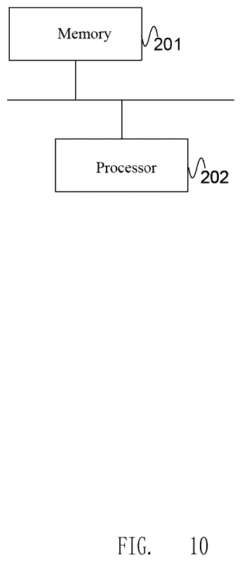

Another implementation of the present invention further provides an electronic device, as shown in FIG. 10, including at least one processor 202; and a memory 201 communicatively connected to the at least one processor 202. The memory 201 stores instructions executable by the at least one processor 202. The instructions, when executed by the at least one processor 202, cause the at least one processor 202 to perform the above method embodiment.

The memory 201 and the processor 202 are connected by a bus. The bus can include any number of interconnected buses and bridges. The bus connects various circuits of the one or more processors 202 to various circuits of the memory 201. The bus can also connect various other circuits such as a peripheral device, a regulator, and a power management circuit, which are well-known in the art. Therefore, they will not be further described herein. A bus interface provides an interface between the bus and a transceiver. The transceiver can be a single element or a plurality of elements, such as a plurality of receivers and transmitters, to provide a unit for communication with various other apparatuses on a transmission medium. Data processed by the processor 202 is transmitted through an antenna on the wireless medium. Further, the antenna receives the data and transmits the data to the processor 202.

The processor 202 is responsible for managing the bus and performing general processing, and can also provide various functions including timing, a peripheral interface, voltage regulation and power management, and other control functions. The memory 201 can be configured to store data used by the processor 202 during operations.

Another implementation of the present application relates to a computer-readable storage medium, having a computer program stored thereon. The computer program, when run by a processor, implements any of the above method embodiments.

That is, those skilled in the art can understand that all or some of the steps in the method of the above embodiments can be completed by instructing relevant hardware through a program. The program is stored in a storage medium and includes several instructions to enable a device (such as a single-chip computer and a chip) or a processor to execute all or some of the steps of the method of the various embodiments of the present invention. The aforementioned storage media include: various media that can store program codes, such as a USB flash drive, a mobile hard disk drive, a Read-Only Memory (ROM), a Random Access Memory (RAM), a magnetic disc, and an optical disc.

Those of ordinary skill in the art can understand that the foregoing various embodiments are specific embodiments of practicing the present invention, while in practical applications, various changes can be made to the implementations in form and detail without departing from the spirit and scope of the present invention.

What is claimed is:

1. A vehicle audio system based on drive channel multiplexing, comprising:
an audio obtaining module, configured to obtain audio source data and an audio mode instruction;
a signal processing module, configured to process a corresponding audio mode for the audio source data according to the audio mode instruction; and
a power amplification module, configured to: receive a signal output by the signal processing module and amplify the signal to obtain an audio signal, wherein the power amplification module is connected to a channel switching module through a group of drive channels,
wherein the channel switching module is connected to a first audio device group and a second audio device group respectively through a first drive sub-channel group and a second drive sub-channel group to switch a first drive sub-channel and/or a second drive sub-channel corresponding to the audio mode to be opened according to the audio mode instruction, to cause the audio signal to drive a target audio device.

2. The vehicle audio system based on drive channel multiplexing according to claim 1, wherein the power amplification module is connected to a portion of first audio devices in the first audio device group and a portion of second audio devices in the second audio device group respectively through two groups of direct drive channels, wherein each direct drive channel is connected to a first audio device or a second audio device.

3. The vehicle audio system based on drive channel multiplexing according to claim 2, wherein the channel switching module is connected to all the first audio devices, except the portion of first audio devices, in the first audio device group through the first drive sub-channel group, and to all the second audio devices, except the portion of second audio devices, in the second audio device group through the second drive sub-channel group,
wherein each first drive sub-channel in the first drive sub-channel group is connected to one first audio device, and each second drive sub-channel in the second drive sub-channel group is connected to one second audio device.

4. The vehicle audio system based on drive channel multiplexing according to claim 1, wherein the channel switching module is connected to all first audio devices in the first audio device group through the first drive sub-channel group, and to all second audio devices in the second audio device group through the second drive sub-channel group, wherein each first drive sub-channel is connected to one of the first audio devices, and each second drive sub-channel is connected to one of the second audio devices.

5. The vehicle audio system based on drive channel multiplexing according to claim 3 or 4, wherein the channel switching module is configured to route and branch the group of drive channels into the first drive sub-channel group and the second drive sub-channel group,
wherein each drive channel in the group of drive channels is routed to one of the first drive sub-channels and one of the second drive sub-channels; and a number of the first drive sub-channels in the first drive sub-channel group is the same as a number of the second drive sub-channels in the second drive sub-channel group.

6. The vehicle audio system based on drive channel multiplexing according to claim 3 or 4, wherein the channel switching module is configured to branch the group of drive channels to the first drive sub-channel group and the second drive sub-channel group,
wherein each drive channel in the group of drive channels is respectively routed to one of the first drive sub-channels and at least one of the second drive sub-channels;
and a number of the first drive sub-channels in the first drive sub-channel group is different from a number of the second drive sub-channels in the second drive sub-channel group.

7. The vehicle audio system based on drive channel multiplexing according to claim 1, wherein the second audio device group is any one of a headrest loudspeaker group, an A/B-pillar loudspeaker group, a ceiling loudspeaker group, a loudspeaker array, and a seat vibrator group; and the first audio device group includes audio devices except the second audio device group among the audio devices of entire vehicle.

8. An audio playing method, applied to the vehicle audio system based on drive channel multiplexing according to claim 1 and comprising:
obtaining audio source data and an audio mode instruction, and processing a corresponding audio mode for the audio source data according to the audio mode instruction;
amplifying the processed audio source data to obtain an audio signal;
switching a first drive sub-channel and/or a second drive sub-channel corresponding to the audio mode to be opened according to the audio mode instruction, to cause the audio signal to drive a target audio device.

9. An electronic device, comprising: at least one processor; and,
a memory communicably connected with the at least one processor, wherein
the memory has instructions executable by the at least one processor; and the instructions, when executed by the at least one processor, cause the hat least one processor to perform the method in claim 8.

10. A computer-readable storage medium, having a computer program stored thereon, wherein the program is run by a processor to implement the method according to claim 8.
